(19) United States
(12) Patent Application Publication
(10) Pub. No.: US 2007/0011448 A1
(43) Pub. Date: Jan. 11, 2007

(54) Using non 5-tuple information with IPSec

(75) Inventors: Avnish K. Chhabra, Bellevue, WA (US); Brian D. Swander, Bellevue, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/175,923

(22) Filed: Jul. 6, 2005

(51) Int. Cl. H04L 9/00

(52) U.S. Cl. 713/151

(57) ABSTRACT

A method of communicating using IPSec security protocol. Security associations are provided for a connection based on session information that may include user information and/or information related to an application running on the device. One or more filters determine whether or not to accept a connection based on session information.

### BACKGROUND OF INVENTION

1. Field of Invention

The invention is related generally to communicating between devices using IPSec security protocol.

2. Discussion of Related Art

Computer networks provide an efficient way to exchange information between two or more computers. Often, the information exchanged between computers is of a sensitive or confidential nature.

Information is exchanged over a network according to one or more protocols, such as the Internet Protocol (IP). IP enables the exchange of information, however, it does not prevent an unauthorized user from receiving, viewing or modifying information transmitted over a network. IP lacks security features, such as the authentication of users or network devices.

To address the lack of security provided by standard IP, the Internet Engineering Task Force (IETF) has developed a set of protocols, referred to as the Internet Protocol Security (IPSec) suite. IPSec protocols are designed to protect traffic based on the standard 5-tuple (source IP address, source port, destination IP address, destination port and protocol). Traffic may be filtered based on 5-tuple information.

IPSec provides protocols that conform to standard IP, but that include security features lacking in standard IP. Specific examples of IPSec protocols include an authentication header (AH) protocol and encapsulating security protocol (ESP). The ESP protocol is an authenticating and encrypting protocol that uses cryptographic mechanisms to provide integrity, source authentication, and confidentiality of data. The AH protocol is an authentication protocol that uses a hash signature in the packet header to validate the integrity of the packet data and the authenticity of the sender.

Two computers in communication over a network negotiate a set of security parameters prior to using the ESP, AH or similar protocols. The negotiated security parameters may be stored in both computers as one or more data structures, referred to as a security association (SA). Parameters stored in the SA identify a security protocol (e.g., ESP or AH), a cryptographic algorithm used to secure communication (e.g., DES, 3DES), keys used with the cryptographic algorithm and a lifetime during which the keys are valid.

One method of negotiating security parameters is by using a negotiation protocol. An example of a negotiation protocol is the internet key management and exchange protocol (IKE), also provided as part of IPSec. During the negotiation, the initiator and the responder may establish one or more SAs.

### SUMMARY OF INVENTION

In one aspect, the invention is directed to a method of communicating between devices over a network. Communicating over a network may pose concerns about the security of the information sent over the network. As one example, it may be desirable to ensure that sensitive information is sent to the correct person. As another example, it may be desirable to protect sensitive information from being viewed and/or changed by a third party.

IPSec security protocol is one method of providing security for communications over a network. When two devices engage in communication, IPSec establishes a security association for a connection between the devices. A security association includes security parameters (e.g., encryption and/or authentication) for a connection. In previous implementations, a device would determine which security association to use for a communication based on the source address, destination address and protocol (i.e., the standard 5-tuple).

In one aspect of the invention, security associations are established for connections based on session information related to a user and/or application. For example, a security association may be selected based on the user of a device. As another example, a security association may be selected based on an application running on the device.

In another aspect of the invention, one or more filters may determine whether a connection will be established based on session information. For example, a filter may examine the identity of a user of another device with which a connection may be established. The filter may determine whether to establish the connection based on the identity of the user of the other device and/or other information.

Providing security based on session information may facilitate implementing security policies over the lifetime of a device. For example, specific security policies may be developed for particular users and/or applications.

In yet another aspect, the invention is directed to a method of communicating over a network using IPSec security protocol. The method includes receiving 5-tuple information and session information. The method also includes determining whether to allow a first connection between a first device and a second device based on at least a portion of the session information. The method further includes establishing a security association for the first connection based on at least a portion of the session information.

In a further aspect, the invention is directed to a computer-readable medium having computer-executable instructions for performing steps. The steps include receiving 5-tuple information and session information. The steps also include determining whether to allow a first connection between a first device and a second device based on at least a portion of the session information. The steps further include establishing a security association for the first connection based on at least a portion of the session information.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch illustrating two devices communicating via prior IPSec security protocols;

FIG. 2 is a sketch illustrating an example of two devices establishing security associations based on user information;

FIG. 3 is a block diagram illustrating an example of a device having software modules that may be used to practice the present invention; and

FIG. 4 is a flow chart illustrating an example of a method of communicating between devices based on session information.

### DETAILED DESCRIPTION

Prior methods of providing security using IPSec focused on the standard 5-tuple. The standard 5-tuple includes the source device port and address, the destination device port and address, and the type of protocol used for the communication. When a connection is established between devices, a security association (SA) is provided that contains security protocols for the connection. When traffic is sent over the network, a device knows which SA to use by checking the 5-tuple information. The 5-tuple can be used to distinguish between devices and device ports, but does not provide information about users and/or applications associated with devices. The inventors have appreciated difficulties that may arise with this approach, for example, when more than one user uses a device.

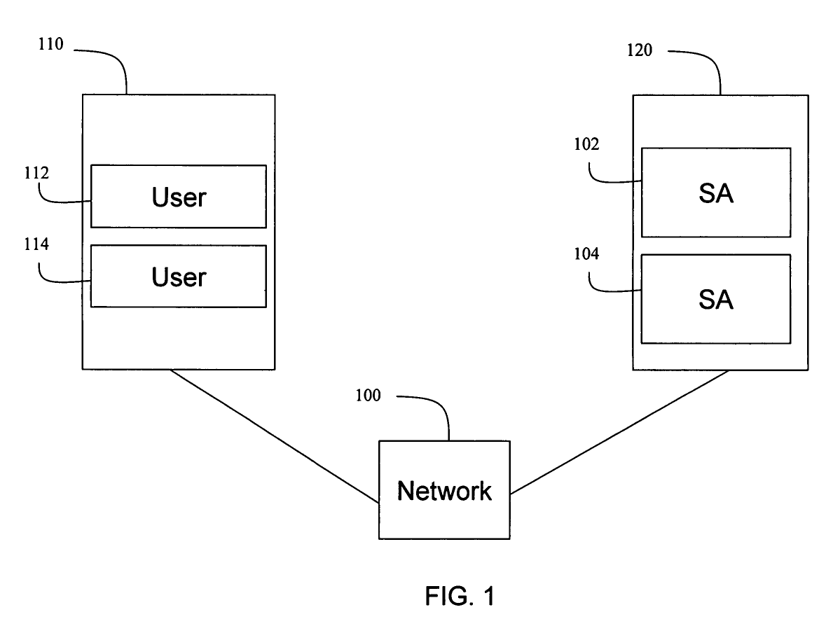

As one example, FIG. 1 is a block diagram illustrating two devices 110 and 120 in communication over a network 100.

A first user 112 may be using device 110 to communicate with device 120. A connection may be established for this communication, and may be provided with an SA 102 that includes particular security parameters. Device 120 may store SA 102 and use it for communications with device 110.

If user 114 now uses device 110 to communicate with device 120, a different SA 104 may be established for this connection. For example, this new connection may require different security parameters than those established for user 112. Device 120 may store SA 104.

Device 120 may now have two different SAs 102 and 104 for communications with device 110. If device 110 now sends traffic to device 120, device 120 may attempt to use 5-tuple information to determine which SA to use. However, device 120 now has two SAs 102 and 104 with identical 5-tuple information and may not be able to determine which SA to use.

The inventors have appreciated that it may be desirable to provide security for communications over a network based on session information. Session information is information related to a connection between devices. For example, session information may include a user identifier identifying a user, an application identifier identifying an application and various rules associated with the connection, the application and/or the user. Session information may be stored in any suitable data structure on a computer-readable medium (e.g., within a device), and may be updated to represent the session as information becomes available.

Providing security based on session information may enable the enforcement of user-based and application-based security policy and simplify the implementation of policy over the lifecycle of a device. User-based and application-based policy may replace or supplement device-specific and port-specific policy.

In one aspect of the invention, SAs may be established for connections based on session information. One example is to establish SAs based on user information. Providing SAs based on user information may facilitate user authentication.

For example, a device 220 may receive a communication request from a device 210. Device 210 may send a user identifier identifying the user of device 210. Once device 220 receives the identifier it may be checked against information that represents existing SAs for connections to the device 210. If an appropriate SA for the user exists, (e.g., an SA for the same user with similar security parameters) then that appropriate existing SA may be used for the connection. If not, a new SA may be established for the user, and the user identifier stored in device 220.

Another example of establishing SAs based on user information will now be described.

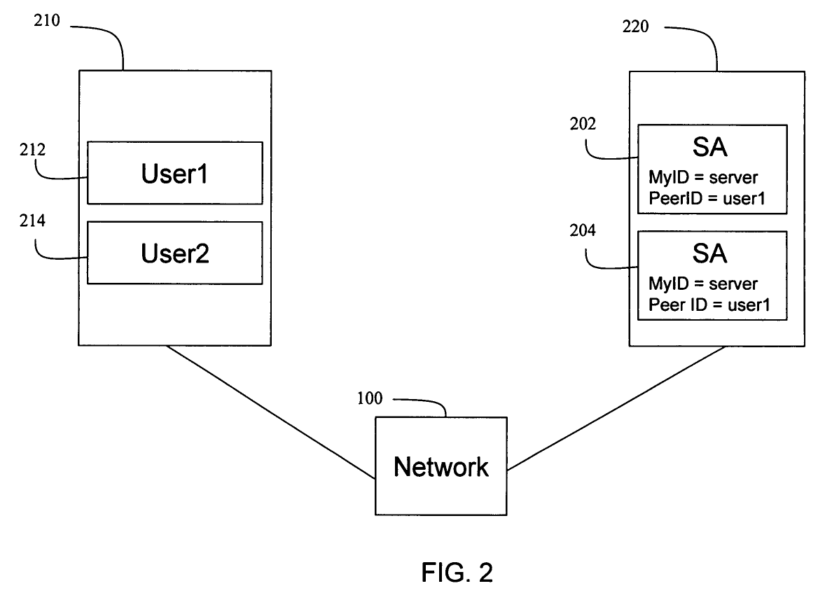

FIG. 2 is a block diagram illustrating an example of a network environment in which the invention may be practiced. The environment includes two devices 210 and 220 communicatively coupled to a network 100. Network 100 may be any suitable type of network such a local area network (LAN), wide area network (WAN), intranet, Internet or any combination thereof. For illustrative purposes, a limited number of devices are shown in this example. However, it is to be appreciated that many devices may be coupled to network 100. Although the devices are illustrated as being coupled directly to the network 100, the devices may be coupled to the network through one or more servers, routers, proxies, gateways, network address translation devices or any suitable combination thereof.

Device 210 and device 220 may be any suitable computing environment, such as a general-purpose computer system described in further detail below, and may communicate by sending packets of data according to any suitable protocol, such as IP. In this example, IPSec is used to provide secure transmission of packets. Device 210 may have two different users who use the device: user 212 and user 214. Each user may have a corresponding identifier, e.g., user1 and user2. The identifier may be the same identifier used to log in to an operating system that runs on device 210.

Users 212 and 214 may, for example, use device 210 to view web pages on a web browser. Device 210 may obtain the web pages by establishing a connection with the device 220 (e.g., a server) using the IPSec protocol. The web pages may, for example, be corporate intranet pages containing corporate information such as employee information or corporate policies. User 212 may, for example, view an intranet page containing sensitive employee data and user 214 may view an intranet page containing the corporate policy information. It may be desirable to encrypt the sensitive employee data and not encrypt the corporate policy information.

A different SA may be provided for each user of device 210 that communicates with device 220. User 212 may be provided with an SA 202 that provides encryption and user 214 may be provide with an SA 204 that does not provide encryption.

When a connection is desired to be established, a negotiation may be conducted to establish security parameters for the connection. The negotiation may select an appropriate SA for a connection, e.g., based on a user identifier. A method of negotiating security parameters is described in co-pending application Ser. No. 10/713,980 entitled, “Method of Negotiating Security Parameters and Authenticating Users Interconnected to a Network,” by Brian D. Swander et al., which is hereby incorporated by reference in its entirety. The negotiated security parameters may be stored in an SA in both devices 210 and 220.

In one aspect of the invention, an SA may be provided for a new connection by selecting an appropriate SA from an existing set of SAs. An appropriate SA may be selected by examining session information associated with the new connection, and determining if an existing SA has security parameters in accordance with the session information. If such an SA exists, the new connection may be provided with the appropriate SA. In another aspect of the invention, if an appropriate SA does not exist, then a new SA may be created. The new SA may have at least one security parameter that is different from existing SAs on the same device.

Once an SAs 202 and 204 are negotiated for connections, traffic may be sent from device 210 to device 220 by user 214. The traffic may arrive at device 220 encapsulated in an SA, and IPSec may use the appropriate SA to decapsulate the traffic. In this case, SA 204 decapsulates the traffic, and device 220 may determine the user ID for the user of device 210 because it is included in SA 204 stored on device 220.

Included in the SA may be an identifier “PeerID” identifying the user of device 210 (user2) who initiated the communication and an identifier “MyID” identifying the user of the device with whom a connection is desired to be established. In this example, device 220 may be a server that is not associated with a particular user. In one embodiment of the invention, the MyID and PeerID information may obtained once the first secure packet arrives inbound on a connection by looking up the Peer ID in the appropriate SA.

Session information may be checked to ensure that an appropriate SA has been established for the communication. For example, once the MyID and PeerID information reach device 220 they may be examined. If the MyID information does not identify device 220, then the packet may be discarded. If the PeerID information does not match an existing connection, then a new negotiation may take place to establish a new SA for the user.

Session information may be updated dynamically as the information becomes available. For example, device 220 may not know the user of device 210 until the first secure packet arrives. The ID of the user of device 210 may then be passed to the operating system kernel of device 220, and the session information updated accordingly for the connection.

In some circumstances, a SA may be established for a connection before all of the session information becomes available. The SA may be conditionally used until the session information is updated. Once the session information is updated, it may be checked to verify that the appropriate SA is used, and that a connection has been established to the correct person and/or application.

In some aspects of the invention, the peer ID of the user of another device may be obtained before sending sensitive information to the other device.

For example, device 210 may initiate a communication with device 220. Device 220 may obtain the Peer ID for device 210 as discussed above. Device 220 may then respond to device 210. Once device 210 receives the response from device 220 it may obtain the Peer ID for device 220 by looking it up in the appropriate SA. Device 210 may pass the user ID for device 220 to the device kernel. The kernel may then update the session information (e.g., in application state table 312) with the peer ID (e.g., server). One the session information is updated, device 210 may determine whether to allow a connection to device 220. For example, if the server is the peer with whom a connection is desired to be established, then further communication may be allowed. In the above example, communication may be allowed to device 220 if the peer ID (server) is associated with a particular security descriptor (SD). If not, the communication may be denied.

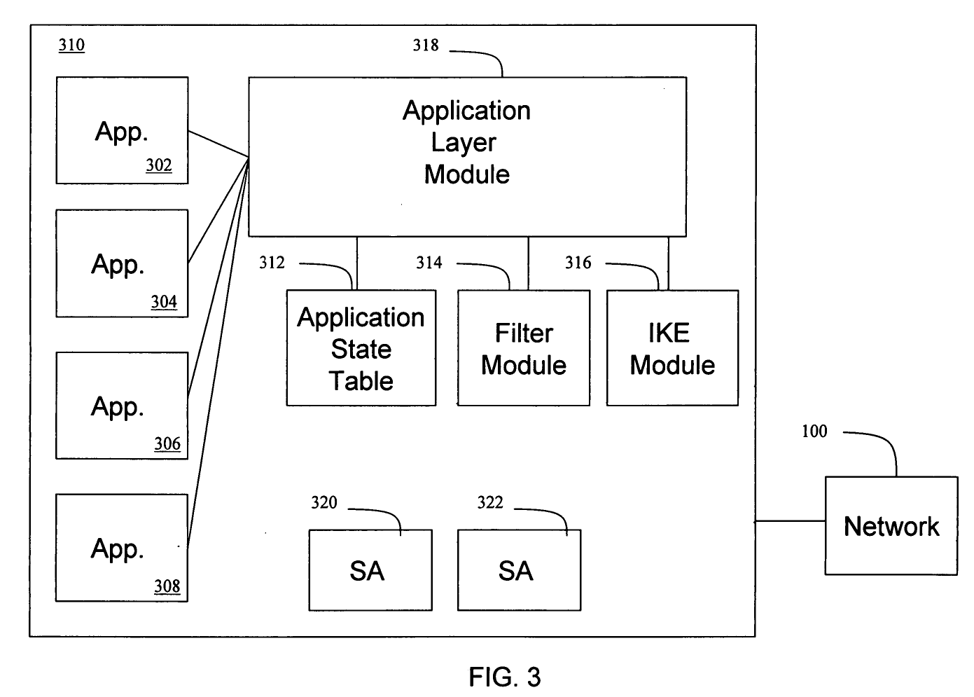

FIG. 3 is a block diagram illustrating software modules and data structures that may include and/or implement aspects of the invention on a device 310 that may be any suitable device. Device 310 may include an application layer module 308, an application state table 312, a filter module 314 and one or more SAs, e.g., SA 320 and SA 322. One or more applications, e.g., applications 302, 304, 306 and 308 may run on device 310.

In some embodiments, SAs may be established based on application information. Application information may include identifiers identifying the applications and/or one or more security rules for an application.

For example, application 302 may have an associated security rule indicating that application 302 must communicate via IPSec a connection over network 300. Application 302 may be provided with SA 320 that provides IPSec security for the connection.

Applications 304, 306 and 308 may have associated security rules indicating that these applications must have an encrypted connection for communication over the network. Applications 304, 306 and 308 may be provided with SA 322 that provides encryption (e.g., using ESP encryption protocol) for their connections.

SAs may be provided for a connection based on more than one type of session information, e.g., the user, the application and application security rules.

In one aspect of the invention, various connections may be provided with the same SA. For example, connections may be provided with the same SA if they have similar or identical session information. One SA may be associated with several connections, therefore the number of SAs established for connections to a device may be less than the number of connections.

Another example of establishing SAs based on security rules will now be described.

A security rule may trigger an appropriate action when a particular application attempts to send or receive communication via a network. Security rules may be included in application state table 312. For example, a security rule may initiate a callout that may set a flag on an endpoint (e.g., the application socket). One particular example of a security rule may be the following.

Application 302, CALLOUT_FLAG_GUARANTEE_SECURITY

In this example, the rule is that application 302 must communicate via IPSec for communications over the network. When a connection is to be established, application layer module 308 may pass the flag CALLOUT_FLAG_GUARANTEE_SECURITY to IKE module 316 which negotiates a SA for the connection. The application layer module 303 may mark the endpoint, and pass the endpoint to the IPSec component which then passes the flag to IKE. Application layer module 303 may allow the connection if the negotiated SA satisfies the security rule, and may deny the connection if it does not satisfy the security rule.

Another particular example of a security rule may be the following.

Application 304, CALLOUT_FLAG_GUARANTEE_ENCRYPTION

In this example, the rule is that application 304 must have an encrypted connection (e.g., using ESP protocol with a suitable encryption method) for communications over the network. When a connection is to be established, application layer module 308 may pass the flag CALLOUT_FLAG_GUARANTEE_ENCRYPTION to IKE module 316 which negotiates a SA for the connection. Application layer module 308 may allow the connection if the negotiated SA provides for encryption. An application may have any number of rules associated with it, e.g., multiple rules.

In one aspect of the invention, one or more filters (e.g., filter module 314 on device 310) may determine whether to allow a connection. A filter may be a software module configured to implement security policy for securing inbound and/or outbound traffic. A method and framework for implementing network policies is described in co-pending application Ser. No. 10/456,093, entitled, “Method and Framework for Integrating a Plurality of Network Policies,” by Brian D. Swander et al., which is hereby incorporated by reference in its entirety.

A filter may include one or more filter rules for determining whether or not to allow a connection. Filter rules may include criteria related to session information. For example, a filter rule may allow a particular group of users on to establish a connection.

As one example, an organization may use an application for viewing and editing billing information for its customers. The organization may wish to limit the persons who can use the application to those in the accounting department. The filter may only allow connections for those users who have user IDs that match a security descriptor (SD) that identifies them as being in the accounting department. Such a SD may be “accounting.” A filter rule limiting access accordingly may be the following.

Traffic appId=billing_application, peerSD=accounting, permit

If the traffic is outbound from a device (e.g., device 310), the user of the device may be identified by the operating system login ID. However, the device may not know the ID of the user to whom the traffic is sent (e.g., the peer ID). It may be desirable to know the ID of the user to whom the traffic is sent before sending sensitive information so that sensitive information is not sent to an unauthorized user.

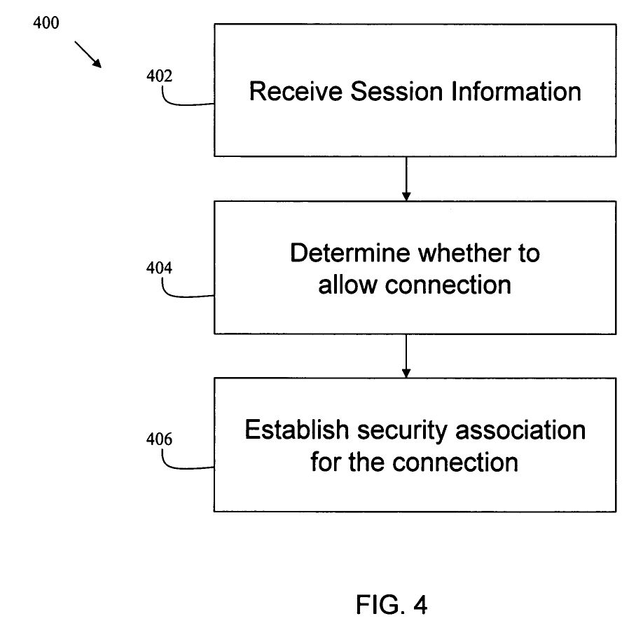

FIG. 4 is a block diagram illustrating an example of a method 400 of communicating over a network using IPSec. Acts that may perform aspects of the invention will now be described.

In an act 402, session information may be received. Any suitable session information may be received, such as information related to a user and/or application associated with a device, e.g., the session information described in the above examples. The session information may be received by the device that initiates the communication, the device that receives the communication, or both devices.

In act 404, it is determined whether or not to allow the connection based on session information. For example, the determination may be based on user-specific and/or application-specific information. In some circumstances it may be desirable to conditionally allow a connection until further session information becomes available (e.g., a peer ID).

In act 406, a security association is established based on session information. An existing security association may be selected, or a new security association may be established. In some circumstances, act 406 may be performed before or during act 404 if a connection is being conditionally allowed.

Acts 402, 404 and 406 need not necessarily be performed in the order recited above, and may be performed in any suitable order. Method 400 may include additional acts. One or more acts of method 400 may be performed concurrently with other acts.

A computing environment that may be used for practicing embodiments of the invention will now be described.

Methods described herein, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs that, as a result of being executed by a computer, instruct the computer to perform one or more of the functions described herein, and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems described herein, may be distributed across one or more of such components, and may be in transition therebetween.

The computer-readable media may be transportable such that the instructions stored thereon can be loaded onto any suitable computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. Further, the embodiments may be located on a single computer or may be distributed among a plurality of computers attached by a communications network.

For example, various aspects of the invention may be implemented as specialized software executing in a general-purpose computer system. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components. The computer system also includes one or more input devices, for example, a keyboard, mouse, trackball, microphone, touch screen, and one or more output devices, for example, a printing device, display screen, speaker. In addition, the computer system may contain one or more interfaces (not shown) that connect the computer system to a communication network (in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system, or in the memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although the computer system discussed by way of example as one type of computer system upon which various aspects of the invention may be practiced, it should be appreciated that aspects of the invention are not limited to being implemented on the computer system. Various aspects of the invention may be practiced on one or more computers having a different architecture or components.

The computer system may be a general-purpose computer system that is programmable using a high-level computer programming language. The computer system may be also implemented using specially programmed, special purpose hardware. In the computer system, the processor is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of communicating over a network using IPSec security protocol, the method comprising acts of:
A) receiving 5-tuple information and session information;
B) determining whether to allow a first connection between a first device and a second device based on at least a portion of the session information; and
C) establishing a security association for the first connection based on at least a portion of the session information.

2. The method of claim 1, wherein the session information comprises a user identifier identifying a user associated with the first device.

3. The method of claim 1, wherein the act C comprises:
establishing security associations for a plurality of connections between the first device and the second device based on a plurality of user identifiers identifying a plurality of users associated with the first device.

4. The method of claim 1, wherein the session information comprises a peer identifier identifying a user associated with the second device.

5. The method of claim 1, wherein the session information comprises at least one security rule.

6. The method of claim 5, wherein the security rule requires encryption for a connection.

7. The method of claim 1, further comprising acts of:
D) receiving a communication from the second device; and
E) determining updated session information at least partially based on the communication received in the act D; and
F) updating the session information to include the updated session information.

8. The method of claim 7, wherein the updated session information comprises a peer identifier identifying a user of the second device.

9. The method of claim 7, further comprising an act of:
G) communicating with the second device at least partially based on the security association, the security association being selected at least partially based on the updated session information.

10. The method of claim 1, wherein the act C further comprises:
selecting, at least partially based on the session information, the security association for the first connection from a set of existing security associations associated with connections between the first device and at least one other device.

11. The method of claim 10, wherein the session information comprises a user identifier, and wherein the security association is selected from the set of existing security associations at least partially based on the user identifier.

12. The method of claim 10, wherein the session information comprises an application identifier, and wherein the security association is selected from the set of existing security associations at least partially based on the application identifier.

13. The method of claim 1, wherein the act C comprises providing a security association that is different from the security associations in the set of existing security associations.

14. A computer-readable medium having computer-executable instructions for performing steps comprising:
A) receiving 5-tuple information and session information;
B) determining whether to allow a first connection between a first device and a second device based on at least a portion of the session information; and
C) establishing a security association for the first connection based on at least a portion of the session information.

15. The computer-readable medium of claim 14, further comprising an application state table comprising at least a portion of the session information.

16. The computer-readable medium of claim 14, further having computer-executable instructions for performing a step comprising:
D) providing different security associations for respective users of the first device for a plurality of connections between the first device and at least one other device.

17. The computer-readable medium of claim 14, further having computer-executable instructions for performing a step comprising:
D) providing the security association for a plurality of connections between the first device and at least one other device, the plurality of connections being associated with similar or identical session information.

18. The computer-readable medium of claim 14, wherein the step C comprises:
providing the security association for a plurality of connections associated with a same user.

19. The computer-readable medium of claim 14, wherein the step C comprises:
providing the security association for a plurality of connections associated with similar or identical security rules.

20. The computer-readable medium of claim 14, wherein the number of connections between the first device and at least one other device is greater than the number of security associations associated with the connections.
